(19) United States
(12) Patent Application Publication
(10) Pub. No.: US 2009/0188475 A1
(43) Pub. Date: Jul. 30, 2009

(54) EGR DEVICE

(76) Inventor: Takahiro Ueda, Kanagawa (JP)

Correspondence Address: MCCORMICK, PAULDING & HUBER LLP, CITY PLACE II, 185 ASYLUM STREET, HARTFORD, CT, 06103, US

(21) Appl. No.: 11/814,097

(22) PCT Filed: Dec. 19, 2005
(86) PCT No.: PCT/JP2005/023249

§ 371 Date: Jul. 17, 2007

(30) Foreign Application Priority Data
Jan. 18, 2005 (JP) 2005010490

(51) Int. Cl. F02M 25/07; F01N 7/00; F01N 5/02

(52) U.S. Cl. 123/568.12; 60/324; 60/320

(57) ABSTRACT

An EGR device comprising an EGR passage 15 for communicating with an exhaust passage 9 of an engine 1 and an air inlet passage 3 to supply a portion of exhaust gas flowing through the exhaust passage 9 to the air inlet passage 3, EGR cooler 16a and 16b provided in the EGR passage 15, for cooling the exhaust gas flowing through the EGR passage 15, and an EGR valve 17 provided in the EGR passage 15, for regulating the flow rate of the exhaust gas supplied from the EGR passage 15 to the air inlet passage 3, wherein a plurality of the EGR coolers (16a and 16b) are provided in the EGR passage 15, and the EGR valve 17 is disposed between any two adjacent EGR coolers 16a and 16b of the plurality of EGR coolers (16a and 16b).

### CROSS REFERENCE TO RELATED APPLICATIONS

This application is entitled to the benefit of and incorporates by reference essential subject matter disclosed in International Patent Application No. PCT/JP2005/023249 filed on Dec. 19, 2005 and Japanese Patent Application No. 2005-010490 filed Jan. 18, 2005.

### TECHNICAL FIELD

The present invention relates to an EGR device for lowering the combustion temperature of fuel-air mixture by supplying a portion of exhaust gas flowing through an exhaust passage of an engine to an air inlet passage, thereby decreasing the NOₓ emission amount, and enables exhaust gas (EGR gas) supplied to the air inlet passage to be cooled to a lower temperature.

### BACKGROUND ART

EGR (exhaust gas recirculation) devices for supplying a portion of the exhaust gas flowing through the exhaust passage to the air inlet passage, holding the combustion temperature of the fuel-air mixture low, and curbing the generation of NOₓ are well known as emission measures in diesel engines and the like and are widely used (see Japanese Patent Application Laid-open No. H10-196462 and the like).

As shown in FIG. 4, for example, an EGR device is provided with an EGR passage 15 for communicating with an exhaust passage 9 of an engine 1 and an air inlet passage 3, an EGR cooler 30 provided in the EGR passage 15, and an EGR valve 31 provided in the EGR passage 15 downstream of the EGR cooler 30.

After the exhaust gas (EGR gas) flowing from the exhaust passage 9 to the EGR passage 15 is cooled by the EGR cooler 30, the flow rate is regulated by the EGR valve 31 and returned to the air inlet passage 3. In FIG. 4, 2 is an air inlet manifold, 7 is an exhaust manifold, 5 is an intercooler, and 12 is a turbo charger.

The reason for cooling the EGR gas with the EGR cooler 30 is that when high-temperature EGR gas is returned to the air inlet passage 3 without any change, the expanded EGR gas due to the high temperature is supplied into the cylinder (combustion chamber), the mass of the EGR gas therefore drops, and the ratio of substantive EGR gas entering the cylinder is reduced. In particular, during high load operation with a large fuel injection quantity, as a large quantity of air is required for combustion, it is necessary to cool the EGR gas to decrease the volume and to ensure the required EGR quantity.

Also, when the EGR gas is cooled, the combustion temperature of the fuel-air mixture decreases, so there is the effect that the NOₓ emission quantity decreases.

In order to increase the NOₓ reduction effect, it has been proposed in recent years to provide a plurality of the EGR coolers 30, as well as to increase the ability and capacity of the EGR cooler 30 to lower the temperature of the EGR gas. SUMMARY OF THE INVENTION

However, if the cooling degree of the EGR gas is enhanced, the hydrocarbon (HC) component contained in the EGR gas condenses or solidifies when passing through the EGR valve 31, becoming a liquid or a solid, which may adhere to the operating parts of the EGR valve 31. When this happens, the operating parts of the EGR valve 31 become stuck, which causes malfunction.

It has therefore been difficult in actuality to enhance the cooling degree of the EGR gas in a conventional EGR engine.

It is therefore an object of the present invention to provide an EGR device for solving the problem described above such that malfunction of the EGR valve does not occur even if the cooling degree of the EGR gas is enhanced.

In order to achieve the above-mentioned object, the present invention is an EGR device comprising an EGR passage for communicating with an exhaust passage of an engine and an air inlet passage to supply a portion of exhaust gas flowing through the exhaust passage to the air inlet passage, an EGR cooler provided in the EGR passage, for cooling the exhaust gas flowing through the EGR passage, and an EGR valve provided in the EGR passage, for regulating the flow rate of the exhaust gas supplied from the EGR passage to the air inlet passage, wherein a plurality of the EGR coolers are provided in the EGR passage, and the EGR valve is disposed between any two adjacent EGR coolers of the EGR coolers.

Here, the ability of the EGR cooler positioned upstream of the EGR valve is favorably set such that the temperature of the exhaust gas passing through the EGR valve is higher than 100° C.

Also, a bypass passage for communicating with the installation position of the EGR valve and a position downstream of one or a plurality of the EGR coolers which is downstream of the EGR valve in the EGR passage may be provided, and the EGR valve may be a directional switching valve capable of selectively flowing the exhaust gas which flows into the EGR valve to either the EGR passage or the bypass passage.

According to the present invention, at least one EGR cooler is disposed downstream of the EGR valve, so even if the EGR cooler (that is, an EGR cooler downstream of the EGR valve) cools the exhaust gas to the condensation or solidification temperature of the hydrocarbon component or lower, no malfunctioning of the EGR valve occurs. Also, according to the present invention, at least one EGR cooler is disposed upstream of the EGR valve, so thermal degradation of the seal member and the like of EGR valve due to high-temperature exhaust gas can be prevented.

### BRIEF DESCRIPTION OF THE DRAWINGS

FIG. 1 is a schematic diagram of the EGR device according to an embodiment of the present invention.

FIG. 2 is a graph showing the temperature of EGR gas flowing through an EGR passage.

FIG. 3 is a schematic diagram of the EGR device according to another embodiment of the present invention.

FIG. 4 is a schematic diagram of a conventional EGR device.

### BEST MODE FOR CARRYING OUT THE INVENTION

### Embodiment 1

A suitable embodiment of the present invention is described below in detail according to the attached drawings.

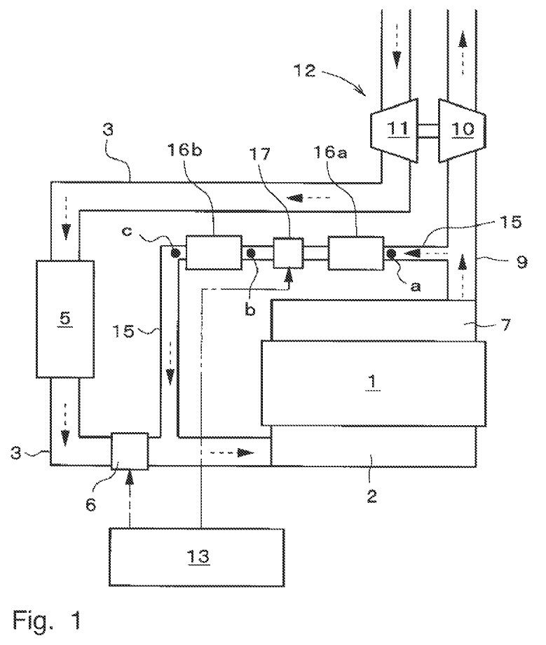

FIG. 1 is a schematic diagram of the EGR device of the present embodiment.

The EGR device of the present embodiment is applied to a diesel engine comprising an engine 1, an air inlet passage 3 connected to the engine 1 through an air inlet manifold 2, an intercooler 5 provided in the air inlet passage 3, a throttle valve 6 provided in the air inlet passage 3 downstream of the intercooler 5, an exhaust passage 9 linked to the engine 1 through an exhaust manifold 7, a turbo charger 12 comprising a turbine 10 provided in the exhaust passage 9 and a compressor 11 provided in the air inlet passage 3, and a controller 13 for electronically controlling various devices such as the throttle valve 6.

The EGR device comprises an EGR passage 15 for communicating with the exhaust passage 9 upstream of the turbine 10 and the air inlet passage 3 downstream of the throttle valve 6, EGR coolers 16a and 16b provided in the EGR passage 15 for cooling exhaust gas (EGR gas) flowing inside the EGR passage 15, and an EGR valve 17 provided in the EGR passage 15 for regulating the flow rate of EGR gas supplied from the EGR passage 15 to the air inlet passage 3.

The degree of opening of the EGR valve 17 can be regulated incrementally or continuously, and is controlled and regulated by the controller 13. The logic of the controller 13 is constructed for determining the optimal degree of opening for the EGR valve 17 at each operating state of the engine 1, and the controller 13 determines a target value of the degree of opening of the EGR valve 17 based on a detected value of a detection means not illustrated such as an engine rotation sensor, an acceleration opening sensor, or an air inlet flow rate sensor, and controls the opening and closing of the EGR valve 17 according to that target value. Because the degree of opening of the EGR valve 17 is optimally controlled and regulated, the flow rate of the EGR gas supplied from the EGR passage 15 to the air inlet passage 3 is suitably controlled and regulated.

As can be understood from FIG. 1, in the EGR device of the present embodiment, the two EGR coolers 16a and 16b are provided in series in the EGR passage 15, and the EGR valve 17 is provided between the EGR coolers 16a and 16b. In further detail, in the EGR device of the present embodiment, each EGR cooler is provided upstream and downstream of the EGR valve 17. In the description below, the EGR cooler 16a upstream of the EGR valve 17 is called the first cooler, and the EGR cooler 16b downstream of the EGR valve 17 is called the second cooler.

The ability and capacity of the first cooler 16a positioned upstream of the EGR valve 17 are set such that the temperature of the EGR gas (exhaust gas) passing through the EGR valve 17 remains above the condensation and solidification temperatures of the hydrocarbon (HC) component contained in the EGR gas. In further detail, the ability and capacity of the first cooler 16a are set such that the temperature of the EGR gas passing through the EGR valve 17 exceeds 100° C.

On the other hand, the ability and capacity of the second cooler 16b positioned downstream of the EGR valve 17 are set such that the temperature of the EGR gas supplied to the air inlet passage 3 is no greater than the condensation or solidification temperature of the hydrocarbon component contained in the EGR gas, that is, no greater than 100° C.

The operation of the EGR device of the present embodiment is next described.

During operation of the engine 1, after a portion of the exhaust gas flowing into the exhaust passage 9 flows into the EGR passage 15 and is cooled to a first temperature by the first cooler 16a, it flows to the EGR valve 17. If the EGR valve 17 is opened at that time according to the degree of opening set by the controller 13, the exhaust gas (EGR gas) flows downstream of the EGR valve 17 at a flow rate corresponding to the degree of opening, and is further cooled to a second temperature lower than the first temperature by the second cooler 16b. The EGR gas then flows into the air inlet passage 3 and is supplied to a cylinder (combustion chamber) of the engine 1 along with (fresh) air supplied from upstream of the throttle valve 6. By supplying low-temperature EGR gas into the cylinder, the combustion temperature and oxygen concentration of the fuel-air mixture decreases, curbing generation of NOₓ.

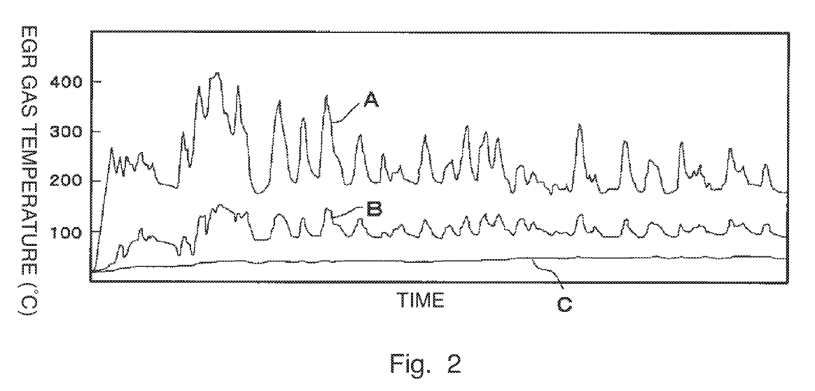

Next, the temperature of the EGR gas flowing inside the EGR passage 15 is described using FIG. 2.

The graph shows the EGR gas temperature at three measurement points inside the EGR passage 15, with line A showing the temperature of the EGR gas flowing in the inlet of the first cooler 16a (point a in FIG. 1), line B showing the temperature of the EGR gas flowing in the inlet of the second cooler 16b (point b in FIG. 1), and line C showing the temperature of the EGR gas flowing in the outlet of the second cooler 16b (point c in FIG. 1).

As can be understood from the graph, the EGR gas temperature at the inlet of the first cooler 16a (line A) is the highest, and the EGR gas temperature at the outlet side of the EGR valve 17, that is, the inlet of the second cooler 16b (line B) decreases to about half of that of line A.

However, the average value of the EGR gas temperature of the inlet of the second cooler 16b (the outlet of the EGR valve 17) (line B) is higher than the condensation and solidification temperatures (approximately 100° C.) of the hydrocarbon (HC) component contained in the EGR gas. As described above, this is because the ability and capacity of the first cooler 16a are set such that the temperature of the EGR gas flowing to the EGR valve 17 does not exceed the condensation and solidification temperatures of the hydrocarbon component. Consequently, the hydrocarbon component of the EGR gas does not liquefy or solidify when passing through the EGR valve 17.

Next, the EGR gas temperature at the outlet of the second cooler 16b (line C) decreases to about half again of the EGR gas temperature at the inlet of the second cooler 16b (line B). The former temperature is lower than the condensation and solidification temperatures of the hydrocarbon component contained in the EGR gas (approximately 100° C.), and is the temperature of the EGR gas supplied to the air inlet passage 3.

As described above, in the EGR device of the present embodiment, the EGR valve 17 is provided between the two EGR coolers 16a and 16b, and the ability and capacity of the EGR cooler 16a positioned upstream of the EGR valve 17 are set such that the temperature of the EGR gas passing through the EGR valve 17 remains greater than the condensation and solidification temperatures of the hydrocarbon component. Therefore, when the EGR gas passes through the inside of the EGR valve 17, the hydrocarbon component of the EGR gas does not liquefy or solidify, so it does not adhere to the operating parts, and malfunctioning of the EGR valve 17 due to such adhering does not occur.

Furthermore, because the EGR cooler 16b is disposed downstream of the EGR valve 17, the EGR gas is adequately cooled by the EGR cooler 16b, and decreases in volume.

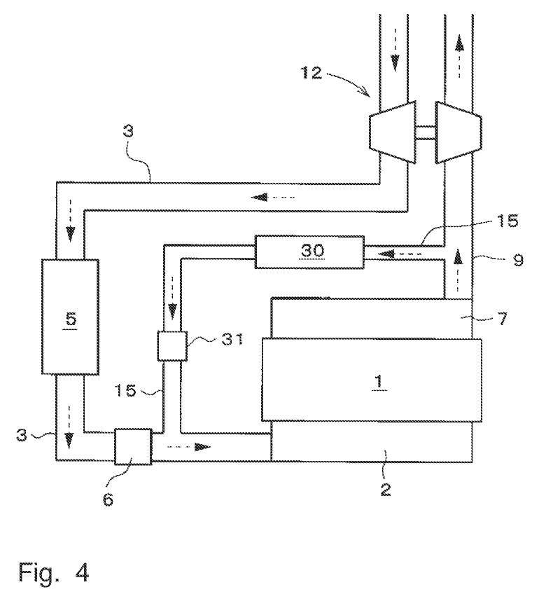

Describing this matter in detail, in a conventional EGR device such as shown in FIG. 4, when the temperature of the EGR gas is decreased by the EGR cooler 30 to the condensation or solidification temperature of the hydrocarbon component or lower, the liquefied or solidified component adheres to the EGR valve 31, causing malfunction, so the EGR gas cannot be cooled to the condensation or solidification temperature of the hydrocarbon component or lower. In contrast, with the EGR device of the present embodiment, the EGR cooler 16b is positioned downstream of the EGR valve 17, so the temperature of the EGR gas can be lowered by the EGR cooler 16b to the condensation or solidification temperature of the hydrocarbon component or lower.

In this manner, with the EGR device of the present embodiment, the EGR gas is cooled lower than conventional temperature, to adequately decrease its volume and to increase the density, so the mass ratio occupied by the EGR gas inside the cylinder of the engine 1 may be increased, and the EGR gas may be supplied inside the cylinder (combustion chamber) at a large ratio. Therefore, the EGR device can be operated even in a high load operation range to decrease the NOₓ.

Furthermore, because the EGR gas can be cooled lower than conventional temperature, the combustion temperature of the fuel-air mixture is lower than conventional temperature, and the NOₓ reduction effect improves.

Furthermore, in the EGR device of the present embodiment, because the EGR cooler 16a (the first cooler) is disposed upstream of the EGR valve 17, thermal degradation of the seal member and the like of the EGR valve 17 can be prevented. In further detail, when high-temperature EGR gas flows to the EGR valve 17 without any change, there is the possibility of thermal degradation occurring to the seal member and the like of the EGR valve 17, but in the EGR device of the present embodiment, the temperature of the EGR gas flowing into the EGR valve 17 can be decreased somewhat, so thermal degradation of the seal member and the like of the EGR valve 17 can be prevented, and the durability of the EGR valve 17 improves. Nevertheless, the ability and capacity of the EGR cooler 16a positioned upstream of the EGR valve 17 are set as described above such that the temperature of the EGR gas flowing to the EGR valve 17 exceeds the condensation and solidification temperatures of the hydrocarbon component.

### Embodiment 2

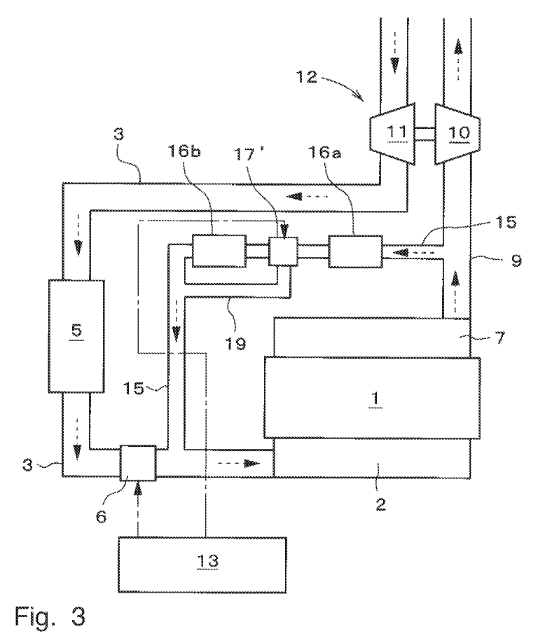

Another embodiment is next described using FIG. 3.

The basic constitution of this embodiment is similar to that shown in FIG. 1, so the same reference numerals are used for constituent elements identical to those in FIG. 1, their description are omitted, and descriptions are provided only for differences.

The characteristic of the present embodiment is that a bypass passage 19 for communicating with the position where an EGR valve 17′ is provided and the position downstream of the EGR cooler 16b (second cooler) positioned downstream of the EGR valve 17′ is provided in the EGR passage 15, and exhaust gas flowing into the EGR valve 17′ can be selectively flowed into either the downstream EGR passage 15 or the bypass passage 19, and a directional switching valve can be used as the EGR valve 17′ to regulate the flow rate.

In this embodiment, the EGR valve 17′ can be switched by the controller 13 to flow the EGR gas passing through the first cooler 16a to the bypass passage 19, so it is not cooled by the second cooler 16b. Overcooling of the EGR gas during cold temperature or low load operation of the engine 1 is thereby avoided to prevent the generation of uncombusted HC, misfire, and the like due to incomplete combustion. To describe in more detail, the controller 13 can switch the EGR valve 17′ based on detected values from a water temperature sensor, load detection sensor (such as an acceleration opening sensor) or the like (for example, during low temperature or low load, flowing the EGR gas to the bypass passage 19, and during high temperature, high load or the like flowing the EGR gas to the EGR passage 15), such that the temperature of the EGR gas supplied to the air inlet passage 3 can thereby always be suitably maintained.

The present invention is not limited to the embodiments described above.

For example, two EGR coolers were provided in the two embodiments described above, but the present invention is not limited in this respect, and three or more EGR coolers may be provided as well. In that case, the EGR valve may be disposed between any adjacent two of the plurality of EGR coolers, and the ability and capacity of one or a plurality of the EGR coolers positioned upstream of the EGR valve may be set such that the temperature of the exhaust gas passing through the EGR valve does not exceed the condensation or solidification temperature (approximately 100° C.) of the hydrocarbon component contained in the EGR gas.

Also, if there are more than one EGR cooler present downstream of the EGR valve, the downstream side of the bypass passage 19 shown in the embodiment of FIG. 3 may be connected to the EGR passage 15 downstream of the furthest downstream EGR cooler, and may be connected to the EGR passage 15 upstream of one or a plurality of the EGR coolers. That is, the bypass passage 19 may communicate with the installation position of the EGR valve 17′ and a position downstream of one or a plurality of the EGR coolers downstream of the EGR valve 17′, and the number of EGR coolers passed through may be reduced when passing through the bypass passage 19 than through the entire EGR passage 15.

While the present invention has been illustrated and described with respect to a particular embodiment thereof, it should be appreciated by those of ordinary skill in the art that various modifications to this invention may be made without departing from the spirit and scope of the present invention.

What is claimed is:

1. An EGR device, comprising:
an EGR passage for communicating with an exhaust passage of an engine and an air inlet passage to supply a portion of exhaust gas flowing through said exhaust passage to said air inlet passage,
an EGR cooler provided in said EGR passage, for cooling the exhaust gas flowing through said EGR passage, and
an EGR valve provided in said EGR passage, for regulating the flow rate of the exhaust gas supplied from said EGR passage to said air inlet passage,
wherein a plurality of said EGR coolers are provided in said EGR passage, and
said EGR valve is disposed between any two adjacent EGR coolers of the plurality of EGR coolers.

2. The EGR device according to claim 1, wherein the ability of the EGR cooler positioned upstream of said EGR valve is set such that the temperature of the exhaust gas passing through said EGR valve is higher than a predetermined temperature.

3. The EGR device according to claim 1, wherein a bypass passage for communicating with an installation position of said EGR valve and a position downstream of one or a plurality of the EGR coolers which is downstream of said EGR valve in said EGR passage is provided, and said EGR valve is a directional switching valve capable of selectively flowing exhaust gas which flows into said EGR valve to either said EGR passage or said bypass passage.

4. The EGR device according to claim 2, wherein a bypass passage for communicating with an installation position of said EGR valve and a position downstream of one or a plurality of the EGR coolers which is downstream of said EGR valve in said EGR passage is provided, and said EGR valve is a directional switching valve capable of selectively flowing exhaust gas which flows into said EGR valve to either said EGR passage or said bypass passage.
